(19) United States
(12) Patent Application Publication
(10) Pub. No.: US 2024/0372613 A1
(43) Pub. Date: Nov. 7, 2024

(54) Apparatus for Fiber Optic Cable Loss Measurement

(71) Applicants: Mark Beranek, Oconomowoc, WI (US); Leonardo Guillen De Mesquita, Bloomington, IN (US)

(72) Inventors: Mark Beranek, Oconomowoc, WI (US); Leonardo Guillen De Mesquita, Bloomington, IN (US)

(73) Assignee: United States of America as represented by the Secretary of the Navy, Patuxent River, MD (US)

(21) Appl. No.: 18/310,090

(22) Filed: May 1, 2023

(51) Int. Cl. H04B 10/079; H04B 10/071; H04B 10/077

(52) U.S. Cl. CPC H04B 10/07955; H04B 10/071; H04B 10/0771

(57) ABSTRACT

An apparatus for fiber optic cable loss measurement includes a control data acquisition and processing unit, a light source for emitting an optical signal toward a fiber optic link under test, a power meter for measuring optical power, a fiber optic reflector, and a fiber optic router. The control data acquisition and processing unit can control the optical power and the wavelength of the light source. The power meter can send optical power data to the control data acquisition and processing unit. The fiber optic reflector reflects the optical signal transmitted through the fiber optic link under test towards the fiber optic router, which routes the light towards the power meter. The power meter measures total optical power input into the fiber optic link under test and measures the total optical power after two passes through the fiber optic link under test and reflected from the fiber optic reflector. The control data acquisition and processing unit calculates a power loss measurement on data sent from the power meter.

### STATEMENT OF GOVERNMENT INTEREST

The invention described herein may be manufactured and used by or for the Government of the United States of America for governmental purposes without payment of any royalties thereon or therefor.

### BACKGROUND

In a typical optical fiber construction, an optical fiber includes a core, a cladding, and a coating. The cladding has a lower refractive index than the core so that light is confined to and travels within the core of the fiber due to total internal reflection. Light is directed to a first end face of the optical fiber and exits at a second end face of the optical fiber. The first and the second end faces are polished ends of the fiber that act as the interface with air or other optical components. The coating protects the fiber from nicks, scratches, and external contaminants. The outer diameter of the cladding is typically, but without limitation, about one hundred and twenty five (125) micrometers and the mode field diameter of a single mode core is about nine (9) micrometers at about one thousand five hundred and fifty (1550) nm wavelength. Multimode fibers utilized in telecommunications applications typically have core diameters ranging between about fifty (50) to about one hundred (100) micrometers. For reference, the diameter of a typical human hair is approximately seventy (70) micrometers.

Dirt or contamination on the end faces of the optical fiber can block or attenuate the light signal between the transmitters and receivers in digital and analog fiber optic links on aircraft, causing link failure and aircraft downtime, which in turn can impact aircraft operational availability. Fiber optic link failures can occur as a result of dirty connectors, damaged connectors, loose connectors, excessively bent optical fiber cable, or broken optical fibers. These faults must be traced and corrected in the fleet or field using fiber optic support equipment. The equipment typically measures optical loss and determines the location of fiber optic optical power attenuation based on maintenance publications. The currently utilized method for measuring optical loss and troubleshooting fiber optic cables on military aircraft is described in the NAVAIR 01-1A-505-4 Technical Manual-Installation and Repair Practices-Aircraft Fiber Optic Cabling WP 007 01 (incorporated herein by reference, but is not admitted to be prior art). The steps of inspecting connectors and the fiber's end face(s) are usually performed at the weapons replaceable assembly (WRA) ends of the fiber optic link, where connectors are readily accessible. Intermediate fiber optic connectors are sometimes either inaccessible or very difficult to access due to their location within aircraft fuselage, wing area, and other structures. Thus, there is need of a more effective apparatus or method to determine if a fiber optic link is not operating properly.

### SUMMARY

The present invention is directed to an apparatus for fiber optic cable loss measurement with the needs enumerated above and below.

The present invention is directed to an apparatus for fiber optic cable loss measurement comprising: a control data acquisition and processing unit: a light source for emitting an optical signal with optical power and wavelength toward and through a fiber optic link under test, the light source communicating with the control data acquisition and processing unit such that the control data acquisition and processing unit can control the optical power and wavelength of the light source; a power meter for measuring optical power, the power meter communicating with the control data acquisition and processing unit such that the power meter can send optical power data to the control data acquisition and processing unit: a fiber optic reflector for reflecting the optical signal transmitted through the fiber optic link under test towards the power meter; and, a fiber optic router for routing light reflected through the fiber optic link under test to the power meter, whereby the power meter measures total optical power input into the fiber optic link under test, measures the total optical power after two passes through the fiber optic link under test and optical power reflected from the fiber optic reflector, and the control data acquisition and processing unit calculates a power loss measurement on data sent from the power meter.

It is a feature of the present invention to provide an apparatus for fiber optic cable loss measurement that is a new and improved way to measure fiber optic cable loss and isolate faults on military aircraft and rotorcraft.

It is a feature of the present invention to provide an apparatus for fiber optic cable loss measurement that only requires accessing the fiber optic cable from one end in order to measure power loss of a fiber optic cable, by relying on a reference calibrated fiber optic reflector attached to the end of the fiber optic link under test.

It is a feature of the present invention to provide an apparatus for fiber optic cable loss measurement that is sensitive to direction dependent loss such as fiber core size mismatch.

### DRAWINGS

These and other features, aspects and advantages of the present invention will become better understood with reference to the following description and appended claims, and accompanying drawings wherein:

FIG. 1 is a block diagram of the apparatus for fiber optic cable loss measurement;

FIG. 2 is a graph of the spectral response, wavelength versus the reflectance of a broadband type fiber optic reflector (this type of fiber optic reflector can be used for one of the potential applications of the invention, in which the fiber optic reflector is only connected to the fiber optic link under test during the installation process):

FIG. 3a is a graph of the spectral response, wavelength versus the reflectance of a comb-type fiber optic reflector (this type of fiber optic reflector can be used for two potential applications of the invention, in which the fiber optic reflector is only connected to the fiber optic link under test during the installation process or when the fiber optic reflector is permanently installed with the fiber optic link);

FIG. 3b is a graph of the spectral response, wavelength versus the reflectance, of a longpass fiber optic reflector (this type of fiber optic reflector can be used for two potential applications of the invention, in which the fiber optic reflector is only connected to the fiber optic link under test during the installation process or when the fiber optic reflector is permanently installed with the fiber optic link);

FIG. 4 is a block diagram of the configuration to measure the optical power output by the apparatus for fiber optic cable loss measurement into the fiber optic link under test:

FIG. 5 is a block diagram of the configuration to measure the level of reflected optical power due to the fiber optic link under test only; and,

FIG. 6 is a block diagram of the configuration to measure the level of output power from the apparatus using the reference fiber optic reflector that comes with the apparatus.

### DESCRIPTION

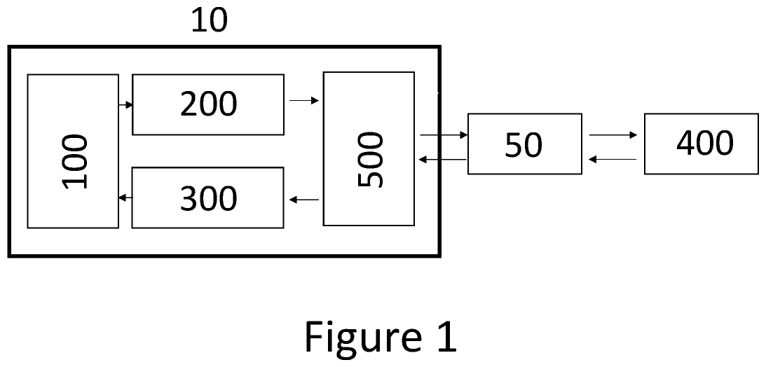

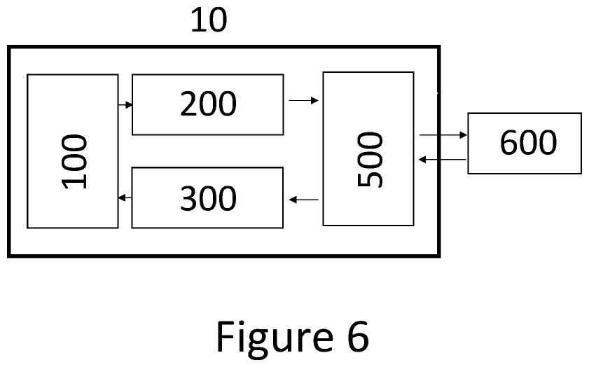

The preferred embodiments of the present invention are illustrated by way of example below and in FIGS. 1-6. As shown in FIG. 1, the apparatus for fiber optic cable loss measurement 10 includes a control data acquisition and processing unit 100, a light source 200 for emitting an optical signal with optical power and wavelength (variable or single depending on the application) toward and through a fiber optic link under test 50, a power meter 300 for measuring optical power, a fiber optic reflector 400, and a fiber optic router 500. The fiber optic router 500 can be, but without limitation, a fiber optic circulator or a fiber optic coupler/splitter. The light source 200 communicates with the control data acquisition and processing unit 100 such that the control data acquisition and processing unit 100 can control the optical power and the wavelength of the light source 200. The power meter 300 communicates with the control data acquisition and processing unit 100 such that the power meter 300 can send optical power data to the control data acquisition and processing unit 100. The fiber optic reflector 400 reflects the optical signal transmitted through the fiber optic link under test 50 towards the fiber optic router 500, which routes the light towards the power meter 300. The power meter 300 measures total optical power input into the fiber optic link under test 50, using a reference calibrated fiber optic reflector 600 as shown in FIG. 6. The power meter 300 also measures the total optical power after two (2) passes through the fiber optic link under test 50 and optical power reflected from the fiber optic reflector 400. The control data acquisition and processing unit 100 calculates a power loss measurement based on data sent from the power meter 300.

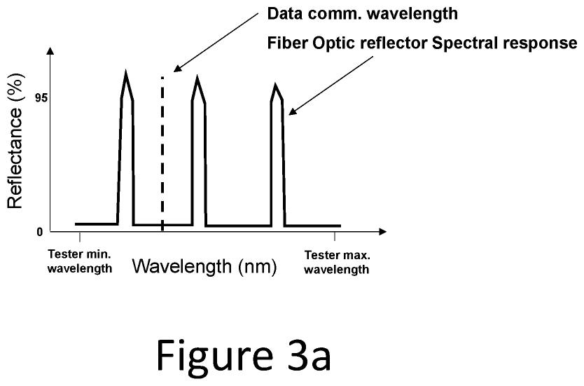

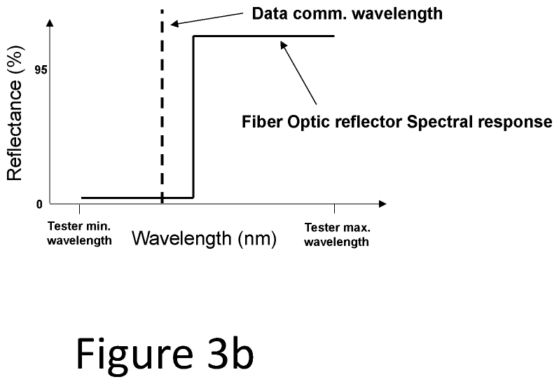

In a preferred embodiment, the apparatus for fiber optic cable loss measurement 10 will support two types of applications or measurement configurations that require slightly different setups and configurations. One application, herein referred to as Application 1, measures link optical power loss in an installed fiber optic link under test 50 with a permanently installed fiber optic reflector 400. This application utilizes, but without limitation, a light source 200 that is a tunable laser and a fiber optic reflector 400 that has a comb-shaped spectral response as shown in FIG. 3a or a longpass spectral response as shown in FIG. 3b. This combination allows the apparatus 10 to differentiate between light reflected by the fiber reflector 400 from light reflected by the fiber optic link under test 50. Another application, herein referred to as Application 2, measures link optical power loss continuously while the fiber optic link under test 50 is installed within an aircraft fuselage. While a tunable laser source and comb-type fiber optic reflector combination can be utilized for Application 2, this application is more lenient and allows for less stringent and less inexpensive requirements for the light source 200 and the fiber optic reflector 400, as compared to Application 1. For Application 2, the light source 200 can be, but without limitation, a fixed wavelength laser or light emitting diode (LED), and the fiber optic reflector 400 can, but without limitation, have a broadband spectral response. Additionally, the apparatus for fiber optic cable loss measurement 10 utilizes a reference calibrated fiber optic reflector 600 that is used to measure the output power from the apparatus for fiber optic cable loss measurement 10.

In the description of the present invention, the invention will be discussed in a military environment: however, this invention can be utilized for any type of application that needs to measure fiber optic cable loss.

The control data acquisition and processing unit 100 may be, but without limitation, an onboard microcontroller with software that accepts user input and guides the user through measurements steps for particular measurement configurations. The apparatus for fiber optic cable loss measurement 10 also stores the calibrated spectral response of the fiber optic reflector 400 that will be used for the measurement. The spectral response of the fiber optic reflector 400 is used by the control data acquisition and processing unit 100 to calculate power loss from the optical power measurements. Based on user input, the control data acquisition and processing unit 100 sends control signals to the light source 200 to adjust its optical power and wavelength launched into the fiber optic link under test 50. Additionally, the control data acquisition and processing unit 100 records optical power as a function of wavelength data from the optical power meter 300 to calculate the optical loss in the fiber optic link under test 50.

In one of the embodiments of the invention, the light source 200 may be a tunable laser or a fixed wavelength laser or Light Emitting Diode (LED), depending on the measurement configuration (Application 1 or 2). The light source 200 provides the optical signal that is used to measure optical power loss through fiber optic link under test 50.

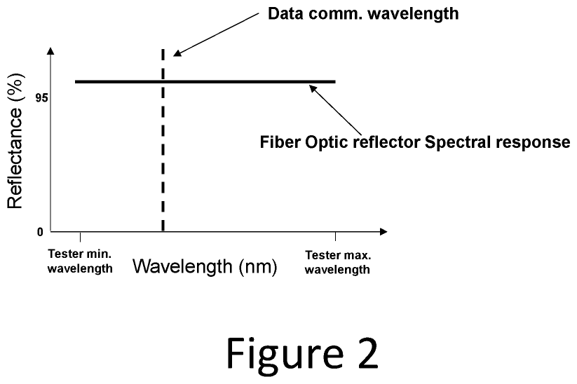

The fiber optic router 500 may be, but without limitations, a fiber optic circulator or a fiber optic coupler/splitter. The fiber optic router 500 serves to route the optical signal emitted by the light source 200 towards and through the fiber optic link under test 50 and route the reflected light from the fiber optic reflector 400 towards the power meter 300. The present invention is used to quantitatively validate the optical performance of the fiber optic link under test 50, which may be, but without limitation, a single mode or multimode fiber optic link. However, the present invention may test any type of fiber optic link practicable. The fiber optic reflector 400 may be, but without limitation, a fiber Bragg grating for single mode fiber optic links only or a fiber optic reflector with dichroic or broadband reflective coating on its end-face. Fiber optic reflectors with coated end-faces can be utilized with single mode and multimode fiber optic links. The fiber optic reflector 400 reflects the optical signal transmitted through the fiber optic link under test 50 towards the power meter 300. The fiber optic reflector 400 provides a calibrated reflection and is the component that allows the power loss measurement to be performed from a single end of the fiber optic link under test 50. The fiber optic reflector 400 can have either, but without limitation, of the spectral responses shown in FIG. 2, 3a, or 3b, depending on the measurement configuration (Application 1 or 2).

In another embodiment of the invention, the power meter 300 may be, but without limitation, a photodiode that converts optical power into electrical current, amplification electronics, or an analog to digital converter that provides a digitized value of optical power measurement to the control data acquisition and processing unit 100. The power meter 300 provides a measurement of the total optical power input into the fiber optic link under test 50 and the total optical power after two (2) passes through the fiber optic link under test 50 and the optical power reflected off the fiber optic reflector 400. The measurements are then processed by the control data acquisition and processing unit 100 to provide a total power loss measurement through the fiber optic link under test 50.

In Application 1, the diagnostics of the installed fiber optic link under test 50 contains the fiber optic reflector 400 at a link end. Since the fiber optic reflector 400 is permanently installed, it transmits the wavelength used for data communication as shown in FIGS. 3a and 3b. This application measures the output optical power of the apparatus for fiber optic cable loss measurement 10 using the configuration shown in FIG. 6, and measures the optical power through the fiber optic link under test 50 and reflected by the fiber optic reflector 400 as shown in FIG. 1.

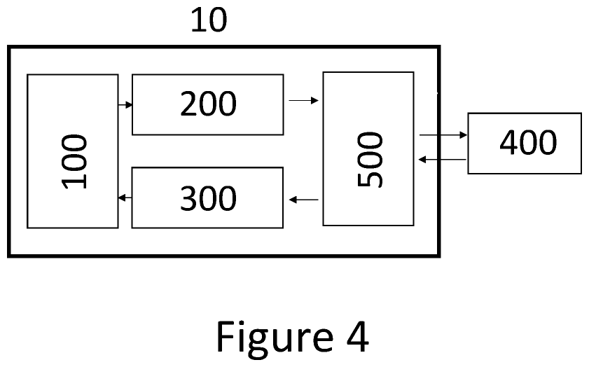

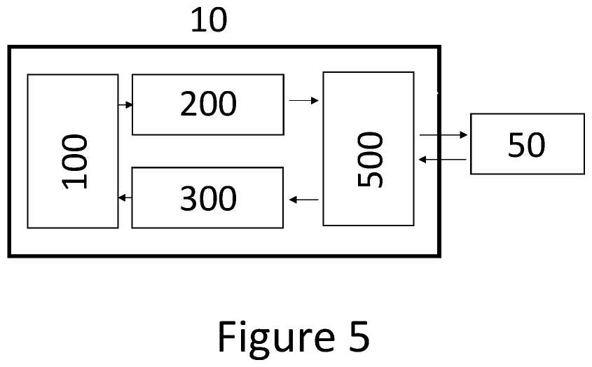

In Application 2, which utilizes a real-time continuous link loss measurement during fiber installation, the fiber optic reflector 400 is connected to the fiber optic link under test 50 only during fiber installation and is removed afterwards. This application measures the output optical power of the apparatus for fiber optic cable loss measurement 10 using the configuration shown in FIG. 4, measures the reflection due to the fiber optic link under test 50 as shown in FIG. 5, and measures the optical power through the fiber optic link under test 50 and optical power reflected by the fiber optic reflector 400 as shown in FIG. 1.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. An apparatus for fiber optic cable loss measurement comprising:
a control data acquisition and processing unit;
a light source for emitting an optical signal with optical power and wavelength toward and through a fiber optic link under test, the light source communicating with the control data acquisition and processing unit such that the control data acquisition and processing unit can control the optical power and wavelength of the light source;
a power meter for measuring optical power, the power meter communicating with the control data acquisition and processing unit such that the power meter can send optical power data to the control data acquisition and processing unit;
a fiber optic reflector for reflecting the optical signal transmitted through the fiber optic link under test towards the power meter; and,
a fiber optic router for routing reflected light from the fiber optic link under test to the power meter, whereby the power meter measures total optical power input into the fiber optic link under test, measures total optical power after two passes through the fiber optic link under test and optical power reflected from the fiber optic reflector, the control data acquisition and processing unit calculates a power loss measurement on data sent from the power meter.
